(19) United States
(12) Patent Application Publication
(10) Pub. No.: US 2008/0129460 A1
(43) Pub. Date: Jun. 5, 2008

(54) Radio Frequency Identification Systems

(76) Inventor: Thomas C. Abraham, Dallas, TX (US)

Correspondence Address: SLATER & MATSIL, L.L.P., 17950 PRESTON RD, SUITE 1000, DALLAS, TX, 75252-5793, US

(21) Appl. No.: 11/949,635

(22) Filed: Dec. 3, 2007

Related U.S. Application Data
(60) Provisional application No. 60/872,165, filed on Dec. 1, 2006.

(51) Int. Cl. H04Q 5/22

(52) U.S. Cl. 340/10.1; 340/572.1

(57) ABSTRACT

A radio frequency identification (“RFID”) system and method of operating the same. In one embodiment, the RFID system includes a reader configured to transmit a command including a parameter profile of a product. The RFID system also includes a sensor tag configured to sense raw data associated with the product, process the raw data to create processed data as a function of the parameter profile and provide the processed data to the reader.

This application claims the benefit of U.S. Provisional Application No. 60/872,165, entitled “RFID Systems,” filed on Dec. 1, 2006, which application is incorporated herein by reference.

### TECHNICAL FIELD

The present invention is directed, in general, to radio frequency identification (“RFID”) systems and, in particular, to an RFID tag and RFID reader of an RFID system and related method for processing raw data associated with a product.

### BACKGROUND

While the core technologies that support radio frequency identification (“RFID”) systems have been around for some time, the applications that drive the use thereof have been slow to market. The aforementioned trend has been turning in an impressive fashion as the size and cost of the RFID tags has decreased and the sensitivity of RFID readers has increased. Moreover, the market forces, especially with respect to the supply chain in the retail industry, are pulling the RFID technologies into the mainstream and literally onto the shelves.

RFID tags are being widely utilized for hands-free information capture. These captured data points can be utilized in a number of ways, from improving supply chain efficiencies to ensuring that a product has maintained its appropriate temperature during the transportation cycle. Some RFID tags have extended memory capacity to log information in a batch memory (on the RFID tag) to download at a later point by an RFID reader. Some RFID tags can have several kilobytes of memory, and sometimes the data transfer rate from the RFID tag to the RFID reader or interrogator can take too much time to provide effective and timely results for the business application. It would be beneficial to reduce the information downloading requirements associated with the RFID tags and RFID readers.

The RFID tags can have extended memory incorporated into an integrated circuit including a processor to enable the storage of data beyond just the unique identification number. This advancement of the technology enables the RFID tag to have more versatility across more use cases in businesses.

Based on the RFID tag's operating frequency, a data transfer rate (“DTR”) is proportionally impacted. In general, the higher the frequency is, the higher the DTR is as well. Certain applications cannot just apply higher operating frequencies as there is correlation to readability and read range as a function of the frequency, for example. So, certain applications of radio frequency identification will not allow for just any frequency to be used, especially due to legal restrictions by governing bodies such as the Federal Communications Commission in the United States.

Another contributor to the problem is that once you have a functioning RFID tag for the business application, the required time to download the data stored on an extended memory RFID tag can require several seconds, maybe minutes. If the use case in the business application does not allow for this time (or it will make the process unfeasibly inefficient), then the technology may not be applied effectively.

Accordingly, what is needed in the art is an RFID system incorporating techniques to transmit information between an RFID tag and an RFID reader that overcomes the deficiencies in the prior art.

### SUMMARY OF THE INVENTION

These and other problems are generally solved or circumvented, and technical advantages are generally achieved, by advantageous embodiments of the present invention that include a radio frequency identification (“RFID”) system and method of operating the same. In one embodiment, the RFID system includes a reader configured to transmit a command including a parameter profile of a product. The RFID system also includes a sensor tag configured to sense raw data associated with the product, process the raw data to create processed data as a function of the parameter profile and provide the processed data to the reader.

In another aspect, a method of operating an RFID system includes transmitting a command including a parameter profile of a product from a reader and sensing raw data associated with the product with a sensor tag. The method also includes processing the raw data to create processed data as a function of the parameter profile with the sensor tag and providing the processed data to the reader.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a system level diagram of an embodiment of an RFID system constructed according to the principles of the present invention;

FIG. 2 illustrates a block diagram of an embodiment of an RFID tag constructed according to the principles of the present invention;

FIG. 3 illustrates a block diagram of an embodiment of an RFID tag in communication with an RFID reader according to the principles of the present invention; and

FIG. 4 illustrates a graph representing a temperature versus time plot for a sample product employable with an RFID system in accordance with the principles of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. Unless otherwise provided, like designators for devices employed in different embodiments illustrated and described herein do not necessarily mean that the similarly designated devices are constructed in the same manner or operate in the same way. The present invention will be described with respect to an exemplary embodiment in a specific context, namely, an RFID system incorporating techniques to transmit information between an RFID tag and an RFID reader. The RFID system is employable in any application and is particularly useful when applied to applications wherein efficient transfer of information between the RFID tag and RFID reader would be beneficial.

In an exemplary embodiment, the RFID system employs rules to process information to be transmitted between the RFID tag and RFID reader. A processor may reside within an integrated circuit of the RFID tag in the form of firmware versus in an application on an application server. As a result, the RFID tag is “smarter” than just a data logging device, and when the RFID tag is interrogated, it may provide the processed data versus a full memory download or the raw data to a host application, thereby requiring less time than the alternative of a full download. Of course, the full download of the RFID tag's payload would still be possible.

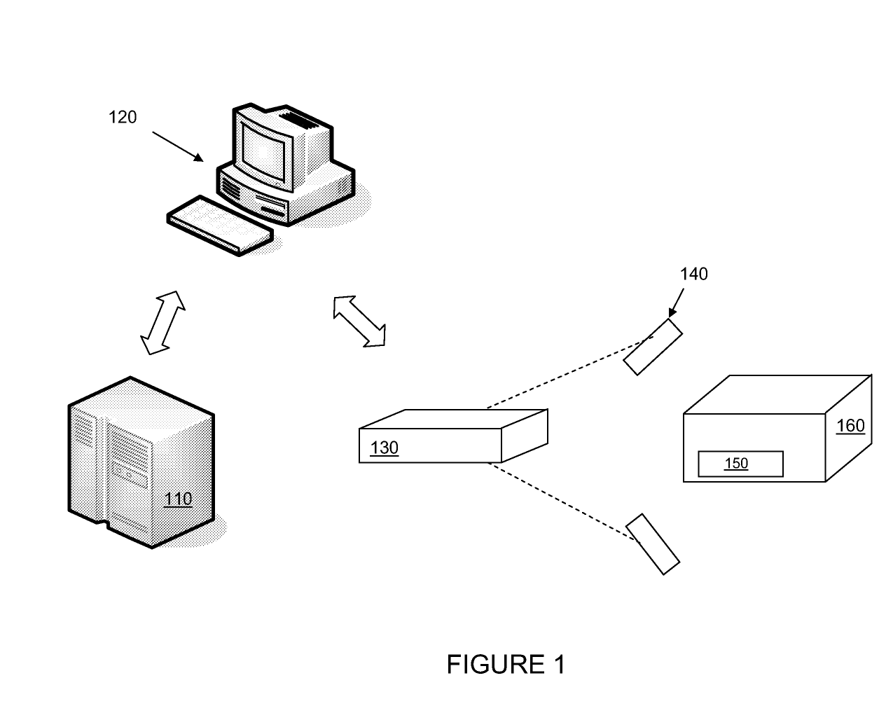

Referring initially to FIG. 1, illustrated is a system level diagram of an embodiment of an RFID system constructed according to the principles of the present invention. The RFID system includes a server 110, a computer system 120, and an RFID reader 130 with antennas (one of which is designated 140). The computer system 120 (in connection with the server 110) directs the RFID reader 130 to read RFID tag(s) 150 located on a product or host material 160. While a single product 160 is illustrated herein, those skilled in the art should understand that the product conceptually may also represent multiple products. In addition, the communication links between respective systems in the RFID system may be wired or wireless communication paths to facilitate the transmission of information therebetween. For a better understanding of communication theory, see the following references “Introduction to Spread Spectrum Communications,” by Roger L. Peterson, et al., Prentice Hall, Inc. (1995), “Modern Communications and Spread Spectrum,” by George R. Cooper, et al., McGraw-Hill Books, Inc. (1986), “An Introduction to Statistical Communication Theory,” by John B. Thomas, published by John Wiley & Sons, Ltd. (1995), “Wireless Communications, Principles and Practice,” by Theodore S. Rappaport, published by Prentice Hall, Inc. (1996), “The Comprehensive Guide to Wireless Technologies,” by Lawrence Harte, et al., published by APDG Publishing (1998), “Introduction to Wireless Local Loop,” by William Webb, published by Artech Home Publishers (1998), and “The Mobile Communications Handbook,” by Jerry D. Gibson, published by CRC Press in cooperation with IEEE Press (1996), all of which are incorporated herein by reference.

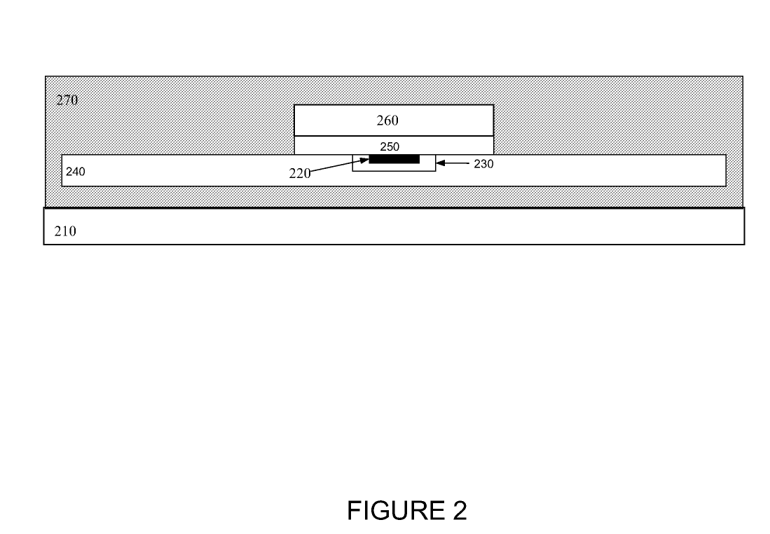

Turning now to FIG. 2, illustrated is a block diagram of an embodiment of an RFID tag constructed according to the principles of the present invention. The RFID tag is affixed or applied to a host material (e.g., a host material including a metal surface or a metal object) 210 and includes an integrated circuit 220 (including memory and a processor) located or embodied in a carrier 230 coupled to an antenna 240. An adhesive 250 is coupled to (e.g., located above and proximate) the carrier 230 and a strain relief member 260 is located above and proximate (e.g., bonded) to the adhesive 250. More particularly, the strain relief member 260 is coupled to the adhesive 250 on a surface opposite the integrated circuit 220 and the carrier 230. In the illustrated embodiment, the adhesive 250 and the strain relief member 260 cover a surface area of the integrated circuit 220 and the carrier 230. The strain relief member 260 provides strain relief for the integrated circuit 220 when the RFID tag is subject to mechanical stress such as compressive or expansive forces. Additionally, the strain relief member 260 may be formed from a temperature resistive material (e.g., a heat resistive material). The RFID tag is encapsulated by an encapsulant 270, which is coupled to and provides an offset for the RFID tag in relation to the host material 210.

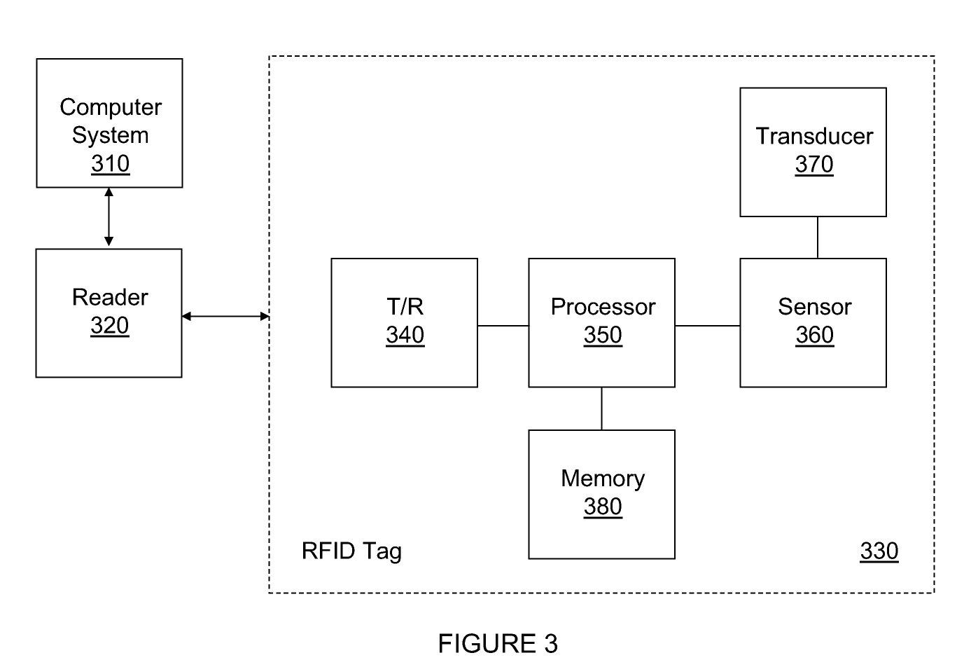

Turning now to FIG. 3, illustrated is a block diagram of an embodiment of an RFID tag in communication with an RFID reader according to the principles of the present invention. A computer system 310 of an RFID system provides a parameter profile for a product including an RFID tag (e.g., sensor tag) 330 to an RFID reader 320. The RFID reader 320 via an antenna transmits a command including the parameter profile of the product to be received by an antenna and a transmitter/receiver 340 of the RFID tag 330. A processor 350 of the RFID tag 330 employs rules to process raw data received via a sensor (e.g., an optical sensor, a temperature sensor, a pressure sensor, and an accelerometer) 360 and a transducer 370 in communication with the product. Upon sensing the raw data associated with the product, the processor 350 processes the raw data to create processed data as a function of the parameter profile. A memory 380 of the RFID tag stores or includes information such as RFID tag identification, a parameter profile of the product, the processed data and the raw data. The processed data is thereafter provided via the transmitter/receiver 340 and an antenna to the RFID reader 320. Thus, rather than sending the raw data, the RFID tag 330 provides the processed data to the RFID reader 320, thereby saving download time therebetween. The aforementioned subsystems of the RFID tag 330 are often embodied in an integrated circuit formed thereon.

In the environment of an example, assume that there is a 4 kilobyte battery-assisted passive RFID tag that logs time and temperature read points. The RFID tag may actually store up to 4000 time/temperature data points (i.e., raw data) in multiple ways. Under the current use case, users must download all of these data points from the RFID tag before any informative decisions may be made such as “do not accept receipt of this product since there was too much temperature abuse or exposure on the product.”

If the use case is RFID tagging every pallet, and the shipment requires 4000 data points of time and temperature for better data granularity (check temperature every minute versus every hour), each pallet of product may require as much as 70 seconds to download the 4000 data points. This could vary depending on the operating frequency of the RFID tag and the actual number of data points logged (potentially less than 4000), and those skilled in the art of RFID understand that this will vary.

After the data download, a processor of the RFID tag processes the raw data to determine how many degree minutes (temperature multiplied by the time interval for each time/temperature read point) a product experienced. Also, many products have an acceptable range of acceptable temperatures around the target or ideal temperature, which forms a temperature profile for the products. Thus, the processor of the RFID tag processes the raw data in real time (e.g., as it is being collected, not after it is downloaded to a host computer system). The host computer system may thereafter make a determination to “Accept” or “Reject” a product based on the processed data.

In accordance with the foregoing, TABLE I provides a table of a sample product with temperature information including data control limits with optimal temperatures.

TABLE I

| | Min. Allowed Temp. | | Max. Allowed Temp. |
|---|---|---|---|
| | (Lower Control Limit, | | (Upper Control Limit, |
| Product | “LCL”) | Target Temp. | “UCL”) |
| ABC | 0° C. | 5° C. | 10° C. |

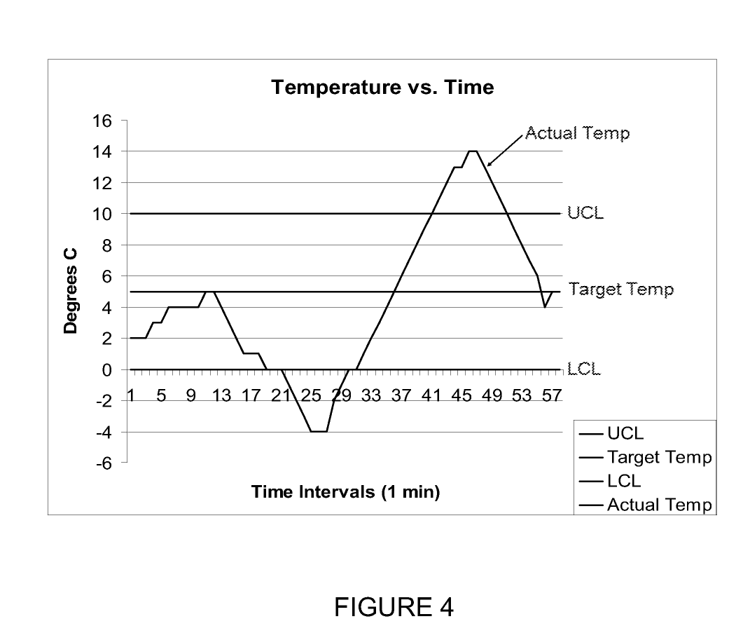

Turning now to FIG. 4, illustrated is a graph representing a temperature versus time plot for the sample product. Other embodiments of this application may utilize cumulative thresholds of time/temperature units (e.g., degree minutes) above the UCL or below the UCL. These are all configurations of the same mathematical functions in this application.

For example, an RFID system may use a rule that if the integral or accumulation of degree minutes above the UCL exceeds 15, then reject the product. The same rule may be applied to the LCL. Conversely, if the processed data are all within the system or configured guidelines for the product (e.g., milk), then the RFID tag could report that particular information (i.e., processed data) in milliseconds since the number of data points has been significantly reduced as the RFID tag is performing these calculations in real time as the time/temperature recordings are made. In such instances, an RFID reader may provide the processed data from the RFID tag to a computer system to determine if the processed data is within guidelines for the product.

It should be noted that if the time intervals are shorter in duration, then the amount of raw data will increase accordingly as more raw data events result (e.g., one read per hour versus one read per millisecond, etc.). So, with the RFID tag processing the data in real time, the amount of processed data remains substantially constant in size (though the magnitude of each value will be changing according to the product profile and the actual sensor readings). The RFID tag's raw data memory storage limits may be exceeded (or eliminated if unnecessary), since the RFID system of the present invention provides a way to have the RFID tag process the raw data immediately into meaningful information, thereby decreasing the need for the raw data. The raw data could still be valuable in determining exactly when abusive readings are recorded, but the process to “Accept” or “Reject” a product may be expedited by employing the processed data.

With the current RFID tag designs, the raw data must be completely downloaded to another application before a decision can be made. The RFID system of the present invention allows a logging of the processed data to provide a “go/no go” decision in sub-second response times.

An embodiment of sample raw data from the RFID tag for the sample product illustrated in accordance with the time/temperature graph of FIG. 4 is provided below in TABLE II.

TABLE II

| | Degree | | UCL > x > | | |
|---|---|---|---|---|---|
| # | Min (x) | x > UCL | Targ. | LCL < x < Targ. | x < LCL |
| 1 | 2 | 0 | 0 | 3 | 0 |
| 2 | 2 | 0 | 0 | 3 | 0 |
| 3 | 2 | 0 | 0 | 3 | 0 |
| 4 | 3 | 0 | 0 | 2 | 0 |
| 5 | 3 | 0 | 0 | 2 | 0 |
| 6 | 4 | 0 | 0 | 1 | 0 |
| 7 | 4 | 0 | 0 | 1 | 0 |
| 8 | 4 | 0 | 0 | 1 | 0 |
| 9 | 4 | 0 | 0 | 1 | 0 |
| 10 | 4 | 0 | 0 | 1 | 0 |
| 11 | 5 | 0 | 0 | 0 | 0 |
| 12 | 5 | 0 | 0 | 0 | 0 |
| 13 | 4 | 0 | 0 | 1 | 0 |
| 14 | 3 | 0 | 0 | 2 | 0 |
| 15 | 2 | 0 | 0 | 3 | 0 |
| 16 | 1 | 0 | 0 | 4 | 0 |
| 17 | 1 | 0 | 0 | 4 | 0 |
| 18 | 1 | 0 | 0 | 4 | 0 |
| 19 | 0 | 0 | 0 | 5 | 0 |
| 20 | 0 | 0 | 0 | 5 | 0 |
| 21 | 0 | 0 | 0 | 5 | 0 |
| 22 | −1 | 0 | 0 | 0 | 1 |
| 23 | −2 | 0 | 0 | 0 | 2 |
| 24 | −3 | 0 | 0 | 0 | 3 |
| 25 | −4 | 0 | 0 | 0 | 4 |
| 26 | −4 | 0 | 0 | 0 | 4 |
| 27 | −4 | 0 | 0 | 0 | 4 |
| 28 | −2 | 0 | 0 | 0 | 2 |
| 29 | −1 | 0 | 0 | 0 | 1 |
| 30 | 0 | 0 | 0 | 5 | 0 |

The parameters in TABLE II include a data record number (“#”), the actual recorded temperature for the time interval (“Degree Min (x)”), the degree minutes value (x) greater than the UCL (“x>UCL”), the degree minutes value less than the UCL and greater than the target temperature (“UCL>x>Targ.”), the degree minutes value greater than the LCL and less than the target temperature (“LCL<x<Targ.”), and the degree minutes value less than the LCL (“x<LCL”).

With an RFID system according to the present invention, the RFID tag can perform RFID tag integrals (the running sums) of the data in the last four categories above to result in the sample time vs. temperature data (i.e., processed data) as provided in TABLE III.

TABLE III

| UCL | Target | LCL |
|---|---|---|
| 10 | 5 | 0 |

| Sum (x) > | UCL > Sum (x) > | | |
|---|---|---|---|
| UCL | Target | LCL < Sum (x) < Target | Sum (x) < LCL |
| 23 | 20 | 72 | 21 |

When the RFID tag is read at the destination, for example, the first set of data that the RFID tag sends is the data labeled “data compression values” in the TABLE III. Four data points will transfer very quickly irrespective of the frequency or the data transfer rate of the RFID tag. Of course, if the full payload of the RFID tag is needed, then the remaining data points may be downloaded, but most of the time the four sums (i.e., the processed data) would be sufficient to make an immediate decision.

If there are persistent problems with rejections, it is reasonable to expect the manufacturer or transporter of the product to review their operations/best practices to mitigate the root cause of the temperature abuse. Then, the products will mostly be received within the proper temperature control limits. Downloading the sum data fields will save hundreds of hours for operators while still providing better information about products than solely instantaneous temperature readings.

Those skilled in the art of radio frequency identification understand that this problem could exist regardless of the RFID tag operating frequency, data transfer rate, and/or the payload or memory of the RFID tag. Oftentimes speed to a decision point is required for a competitive edge in business, and what is needed is an RFID tag that can log data points or process the raw data more efficiently via a processor described herein.

Also, those skilled in the art of sensor technologies understand that these devices are not limited to temperature, but could include numerous other sensor devices. This invention provides temperature sensors as an embodiment, but other embodiments are comprehended in this invention. Other embodiments may include, but are not limited to, shock, voltage, current, humidity, strain, material stresses, optical/light exposure, emissions, radiation/heat signatures, or viscosity profiles of a product.

Thus, an RFID system and method of operating the same has been introduced herein. In one embodiment, the RFID system includes a reader configured to transmit a command including a parameter profile of a product. The RFID system also includes a sensor tag configured to sense raw data associated with the product, process the raw data to create processed data as a function of the parameter profile and provide the processed data to the reader. The RFID system also includes a computer system configured to provide the parameter profile of the product to the reader. The reader is also configured to provide the processed data to the computer system to determine if the processed data is within guidelines for the product.

Additionally, a transmitter/receiver of the sensor tag is configured to receive the command from the reader and provide the processed data to the reader. A processor of the sensor tag is configured to apply rules to process the raw data to create the processed data. A sensor (e.g., an optical sensor, a temperature sensor, a pressure sensor, and an accelerometer) of the sensor tag is configured to sense the raw data via a transducer thereof. A memory of the sensor tag includes information selected from the group consisting of tag identification, the parameter profile of the product, the processed data, and the raw data. Additionally, the parameter profile of the product is selected from the group consisting of a temperature profile of the product, a shock profile of the product, a voltage profile of the product, a current profile of the product, a humidity profile of the product, a strain profile of the product, material stresses profile of the product, optical/light exposure profile of the product, emissions profile of the product, radiation/heat signature profile of the product and a viscosity profile of the product. Additionally, a rate of providing the processed data to the reader is a function of an operating frequency of the sensor tag.

For a better understanding of RFID technologies, in general, see “RFID Handbook,” by Klaus Finkenzeller, published by John Wiley & Sons, Ltd., 2nd edition (2003), which is incorporated herein by reference. For a better understanding of RFID tags in compliance with the EPC, see “Technical Report 860 MHz-930 MHz Class I Radio Frequency Identification Tag Radio Frequency & Logical Communication Interface Specification Candidate Recommendation,” Version 1.1, November 2002, promulgated by the Auto-ID Center, Massachusetts Institute of Technology, 77 Massachusetts Avenue, Bldg 3-449, Cambridge Mass. 02139-4307, which is incorporated herein by reference. For a better understanding of conventional RFID readers, see the following RFID readers, namely, “MP9320 UHF Long-Range Reader,” provided by SAMSys Technologies, Inc. of Ontario, Canada, “MR-1824 Sentinel-Prox Medium Range Reader,” by Applied Wireless ID of Monsey, N.Y. (see also U.S. Pat. No. 5,594,384 entitled “Enhanced Peak Detector,” U.S. Pat. No. 6,377,176 entitled “Metal Compensated Radio Frequency Identification Reader,” U.S. Pat. No. 6,307,517 entitled “Metal Compensated Radio Frequency Identification Reader”), “2100 UAP Reader,” provided by Intermec Technologies Corporation of Everett, Wash. and “ALR-9780 Reader,” provided by Alien Technology Corporation of Morgan Hill, Calif., all of which are incorporated by reference.

Furthermore, for a better understanding of standards base work regarding RFID, see the EPCglobal standards and related publications, namely, EPCglobal release EPC Specification for Class 1 Gen 2 RFID Specification, December 2004, and a “Whitepaper: EPCglobal Class 1 Gen 2 RFID Specification,” published by Alien Technology Corporation, Morgan Hill, Calif. (2005). For a better understanding of RFID devices, see U.S. Pat. No. 6,853,087, entitled “Component and Antennae Assembly in Radio Frequency Identification Devices,” to Neuhaus, et al., issued Feb. 8, 2005. For related applications, see U.S. Patent Application Publication No. 2006/0212141, entitled “Radio Frequency Identification-Detect Ranking System and Method of Operating the Same,” Abraham, Jr., et al., published Sep. 21, 2006, U.S. Patent Application Publication No. 2006/0212164, entitled “Radio Frequency Identification Application System,” to Abraham, Jr., et al., published Sep. 21, 2006, U.S. Patent Application Publication No. 2007/0229284, entitled “Radio Frequency Identification Tag and Method of Forming the Same,” to Svalesen, et al., published Oct. 4, 2007, and U.S. patent application Ser. No. 11/876,978, entitled “Asset Including a Radio Frequency Identification Tag and Method of Forming the Same, to Svalesen, et al., filed Oct. 23, 2007. The aforementioned references, and all references herein, are incorporated herein by reference in their entirety.

Also, although the present invention and its advantages have been described in detail, it should be understood that various changes, substitutions and alterations can be made herein without departing from the spirit and scope of the invention as defined by the appended claims. For example, many of the materials and structures discussed above can be implemented in different materials and structures to advantageously form an RFID tag as described herein.

Moreover, the scope of the present application is not intended to be limited to the particular embodiments of the process, machine, manufacture, composition of matter, means, methods and steps described in the specification. As one of ordinary skilled in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A radio frequency identification (RFID) system, comprising:
a reader configured to transmit a command including a parameter profile of a product; and
a sensor tag configured to sense raw data associated with said product, process said raw data to create processed data as a function of said parameter profile and provide said processed data to said reader.

2. The RFID system as recited in claim 1 further comprising a computer system configured to provide said parameter profile of said product to said reader.

3. The RFID system as recited in claim 1 wherein said reader is configured to provide said processed data to a computer system to determine if said processed data is within guidelines for said product.

4. The RFID system as recited in claim 1 wherein a transmitter/receiver of said sensor tag is configured to receive said command from said reader and provide said processed data to said reader.

5. The RFID system as recited in claim 1 wherein a processor of said sensor tag is configured to apply rules to process said raw data to create said processed data.

6. The RFID system as recited in claim 1 wherein a sensor of said sensor tag is configured to sense said raw data via a transducer thereof.

7. The RFID system as recited in claim 1 wherein a sensor of said sensor tag is configured to sense said raw data and is selected from the group consisting of:
an optical sensor,
a temperature sensor,
a pressure sensor, and
an accelerometer.

8. The RFID system as recited in claim 1 wherein a memory of said sensor tag includes information selected from the group consisting of:
tag identification,
said parameter profile of said product,
said processed data, and
said raw data.

9. The RFID system as recited in claim 1 wherein said parameter profile of said product is selected from the group consisting of:
a temperature profile of said product,
a shock profile of said product,
a voltage profile of said product,
a current profile of said product,
a humidity profile of said product,
a strain profile of said product,
a material stresses profile of said product,
an optical/light exposure profile of the product,
an emissions profile of the product,
a radiation/heat signature profile of the product, and
a viscosity profile of said product.

10. The RFID system as recited in claim 1 wherein a rate of providing said processed data to said reader is a function of an operating frequency of said sensor tag.

11. A method of operating a radio frequency identification (RFID) system, comprising:
transmitting a command including a parameter profile of a product from a reader;
sensing raw data associated with said product with a sensor tag;
processing said raw data to create processed data as a function of said parameter profile with said sensor tag; and
providing said processed data to said reader.

12. The method as recited in claim 11 further comprising providing said parameter profile of said product to said reader.

13. The method as recited in claim 11 further comprising determining if said processed data is within guidelines for said product.

14. The method as recited in claim 11 wherein a transmitter/receiver of said sensor tag receives said command from said reader and provides said processed data to said reader.

15. The method as recited in claim 11 wherein said processing applies rules to process said raw data to create said processed data.

16. The method as recited in claim 11 wherein a sensor of said sensor tag senses said raw data via a transducer thereof.

17. The method as recited in claim 11 wherein a sensor of said sensor tag senses said raw data and is selected from the group consisting of:
an optical sensor,
a temperature sensor,
a pressure sensor, and
an accelerometer.

18. The method as recited in claim 11 further comprising storing information on said sensor tag selected from the group consisting of:
tag identification,
said parameter profile of said product,
said processed data, and
said raw data.

19. The method as recited in claim 11 wherein said parameter profile of said product is selected from the group consisting of:
a temperature profile of said product,
a shock profile of said product,
a voltage profile of said product,
a current profile of said product,
a humidity profile of said product,
a strain profile of said product,
a material stresses profile of said product,
an optical/light exposure profile of the product,
an emissions profile of the product,
a radiation/heat signature profile of the product, and
a viscosity profile of said product.

20. The method as recited in claim 11 wherein a rate of providing said processed data to said reader is a function of an operating frequency of said sensor tag.
